(19) United States
(12) Patent Application Publication
(10) Pub. No.: US 2012/0159894 A1
(43) Pub. Date: Jun. 28, 2012

(54) PU DOOR CONSTRUCTION AND METHOD

(76) Inventor: Jim Chuang, Diamond Bar, CA (US)

(21) Appl. No.: 12/977,560

(22) Filed: Dec. 23, 2010

(51) Int. Cl. E04C 2/34; B29C 33/38

(52) U.S. Cl. 52/784.1; 264/219

(57) ABSTRACT

A door has a wood frame core generally shaped as a planar plank having a first side and a second side. A polyurethane outer layer encapsulates the wood frame plank core, and the polyurethane outer layer has a density of preferably about 350-600 kg/m³. A plurality of concave embossments disposed on the polyurethane outer layer. An AB formula forms the polyurethane outer layer, and has a formula including a first component comprising a Polyol of at least 90% by weight, and a second component including Lupranat M20S. The wood frame core optionally includes strips of wood material disposed on the wood frame core for building up portions of the wood frame core. The fingerjoint plywood is preferably 25 mm thick and 10.7 kg and can be about 22-23 mm thickness.

### FIELD OF THE INVENTION

The present invention is in the field of entry doorways and doors.

### DISCUSSION OF RELATED ART

Traditionally, front doors have been made as wooden planks. Earlier doors had polyurethane (PU) foam injected inside to a core of a door with the exterior being some kind of veneer such as metal, PVC or fiberglass. Fiberglass doors traditionally used compression to stamp the surface and create the door's design. Other improvements have been made in applying a skin layer of polyurethane over the surface of the door, and for strengthening doors containing polyurethane.

For example, Conger in United States patent titled Foamed Polyurethane Laminates U.S. Pat. No. 3,630,819 patented Dec. 28, 1971 provides a method of making polyurethane resin having a decorative film cover, the disclosure of which is incorporated herein by reference. The Conger reference discusses how a previous construction of polyurethane doors used plywood to sandwich the polyurethane resin between the plywood to provide structural strength. In Gerson, titled Panel Door And Method Of Construction U.S. Pat. No. 4,072,548 issued Feb. 7, 1978, the disclosure of which is incorporated herein by reference, a panel door comprised of a rectangular woodframe had a plywood panel laminated to front side and a polyvinyl chloride layer laminated on the inside.

A variety of methods for skin formation details have been described in the prior art such as Green U.S. Pat. No. 5,075,059 issued Dec. 24, 1991 entitled method for forming panel door with simulated wood grains, the disclosure of which is incorporated herein by reference. A polyester door skin having an outer surface can be embossed with wood grains.

### SUMMARY OF THE INVENTION

A door has a wood frame core generally shaped as a planar plank having a first side and a second side. A polyurethane outer layer encapsulates the wood frame plank core, and the polyurethane outer layer has a density of preferably about 350-600 kg/m³. A plurality of concave embossments disposed on the polyurethane outer layer. An AB formula forms the polyurethane outer layer, and has a formula including a first component comprising a Polyol of at least 90% by weight, and a second component including Lupranat M20S. The wood frame core optionally includes strips of wood material disposed on the wood frame core for building up portions of the wood frame core. The fingerjoint plywood is preferably 25 mm thick and 10.7 kg and can be about 22-23 mm thickness.

The AB formula comprises: a first component comprising by weight: Polyol 90-96%; Additive 1-3%; EG 0.5-1.5%; H₂O 0.07-0.20%; SI 02 0.5-1.5%; Catalyst T-9 0.04-0.12%; Catalyst LV-33 0.30-0.90%; Catalyst C-100 0.30-0.90%; and a second component comprising by weight: Lupranat M20S 100%.

The method of constructing the door includes the general steps of: preparing a model door; forming a mold frame; forming a mold, comprising the steps of: laying a first layer of epoxy resin, a hardening agent and a structural cloth; laying a second layer of fine sand having additional epoxy resin and additional hardening agent bonded to the first layer; laying a conduit pipe on the second layer; and laying a third layer of quartz sand having additional epoxy resin and additional hardening agent over the conduit pipe. The method also requires the steps of: forming a a wood frame core generally shaped as a planar plank having a first side and a second side, and placing the wood frame core into the mold; preparing an AB formula which is a polyurethane mixture having a formula comprising a first component comprising a Polyol of at least 90% by weight, and a second component comprising Lupranat M20S; injecting the polyurethane mixture into the mold to form a polyurethane outer layer, wherein the polyurethane outer layer encapsulates the wood frame plank core, wherein the polyurethane outer layer has a density of 350-600 kg/m³; forming a plurality of concave embossments disposed on the polyurethane outer layer; waiting for the polyurethane mixture to cure; and removing the door from the mold.

### BRIEF DESCRIPTION OF THE DRAWINGS

FIG. 1 is a diagram of the core.

FIG. 2 is a diagram of the mold.

### DETAILED DESCRIPTION OF THE PREFERRED EMBODIMENTS

A specific recipe for making a polyurethane door is described as follows. The door has a fingerjoint plywood frame and PU is injected and bonded to the exterior surface of the fingerjoint frame to form the outer layer. The outer layer is not a skin which is embossed onto or rolled on or adhered onto the fingerjoint frame, but rather is formed in a mold onto the fingerjoint frame. The door's surface receives a high level of detail, which is more than traditional fiberglass or other composite doors. The outer PU layer is especially well suited for simulated wood grain detail.

The polyurethane layer can also create raised mouldings on the front and back exterior surface of the fingerjoint plywood frame. The fingerjoint plywood frame is a plank that is substantially flat, but not necessarily smooth. During the molding process, raised mouldings are created with about the same shape and detail as wood doors.

The PU mixture is formulated at a high density so as to feel as solid as wood. The doors are made with a density of 450-500 kg/m3, similar to a solid wood door density, and higher than typical composite doors. The finished product can be used for both exterior and interior, unlike most existing composite doors that need a special coating material to weatherproof the door. After production, the quality control requires the step of checking the door to see if the PU door is sealed so that it is weatherproof, resisting water, heat and termites. The density is also checked to determine if the PU door has proper density for maintaining a high inherent insulation value and good sound insulation.

The PU door is preferably environmentally friendly, and can be recycled easily so that the fingerjoint plywood inside is made from excess wood such as wood scraps.

The first step is preparing the model door. The first model will be used as a master copy for making the other production doors according to the present invention. The model door should be measured, and minor flaws on the model door should be repaired with polyester resin. After repairing, the entire door should be left standing for 60 to 90 minutes for hardening of the polyester resin. The door should then be sanded in its entirety with fine sandpaper. The door service should be brushed with a copper brush to clean and enhance the wood grain detail. A heated air gun can spray water based white wax onto the door surface. The wax then needs to be hardened. The door is inserted into an oven for hardening the wax. The door needs to be inserted into the oven 5-6 times, for baking at about 20 minutes each time, at a temperature of about 45 degrees Celsius each time. After baking, the model door is prepared. A single model door is required for each style of door. The model door is preferably a wooden door.

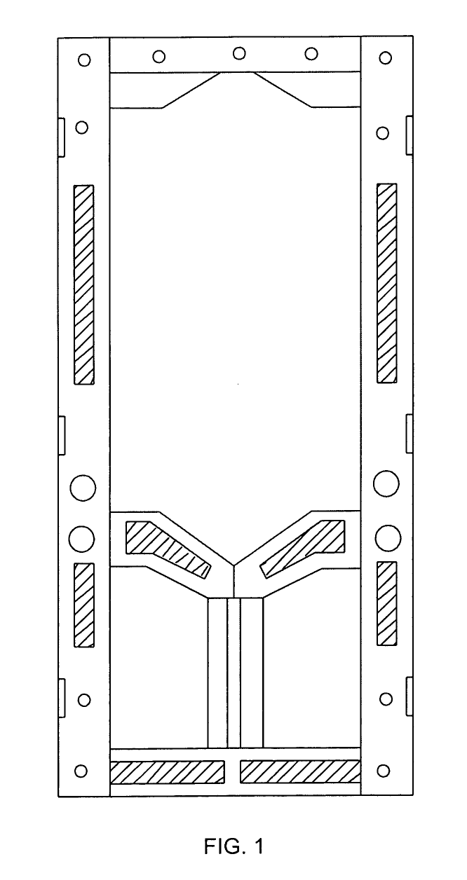

The second step is to create the steel mold frame. A steel mold frame is made for the mold to be placed in. The steel mold frame is shown in FIG. 1. A single steel mold frame is also required for a style of door. A single steel mold friend is able to make more than one door.

The third step is to create the mold that is put into the steel mold frame. The mold is created with the top side preferably created first. The model door is secured into the mold frame with screws. Then, all substances used to make each layer are arranged and applied as appropriately.

Layers to make the mold:

1st Layer

R:H=100:0.8

R—Epoxy resin (Rengel SW 404)

H—Hardening agent

2nd Layer

CaCO₃:Fine Sand:X=1:1:1

where X is R:H=100:40

3rd Layer

Quartz Sand:H=100:10

The first layer is applied to the door and then allowed to dry for 20 minutes. Steel frame bars are connected around the edge of the door. A fiberglass cloth is placed on top of the first layer with resin. A second layer is then applied and allowed to dry for 30 minutes. A third layer is then applied. A copper pipe of approximately 10 mm in diameter is preferably placed on top of the third layer in a zigzag configuration. After the third layer application, the fourth layer is a layer of 15 mm of fine quartz sand and can be shaped by using a piece of wood to flatten the top surface of the sand that is away from the model door upper surface. A water heater or oil heater is then used to keep the mold through the copper pipe that is arranged in a zigzag configuration. The copper pipe heats the mold at a temperature of approximately 80° Celsius for approximately at least two hours. After the wall is completed, the water heater is turned off and the mold is no longer being heated. The mold is then left to dry for approximately 24 hours. The process is repeated for the bottom side of the door, or the opposite side of the door. When the mold is created, the mold has a top half and the bottom half. A single mold is required for each style of door.

The fourth step is to create the fingerjoint frame. Each door will require a single fingerjoint frame. The frame is preferably made of fingerjoint plywood allowing screws to security locks, and for attaching handles and hanging the door. The fingerjoint plywood frame also facilitates removal from the mold after the injection process.

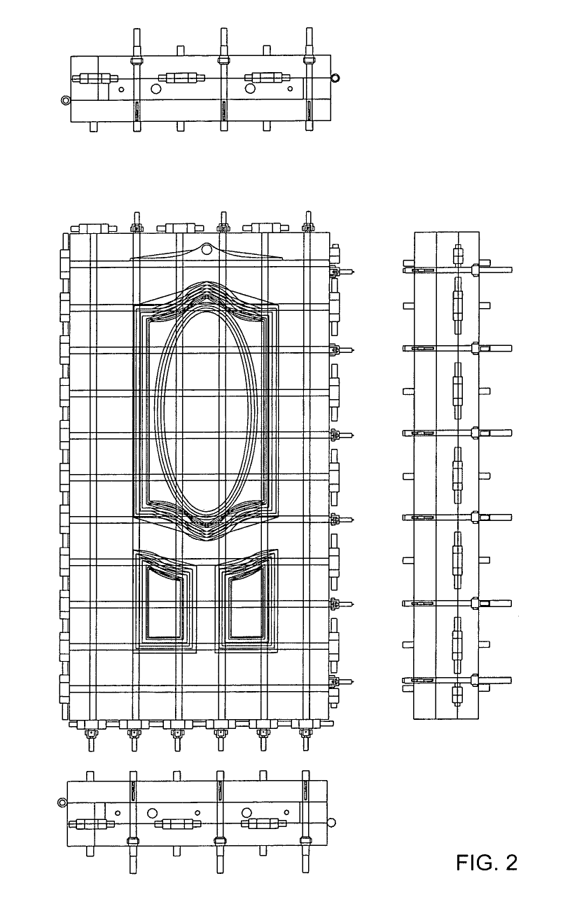

The fingerjoint plywood is preferably 25 mm thick and 10.7 kg and can be about 22-23 mm thickness as well. The drawing of the finger joint frame is shown in FIG. 2. Portions of the fingerjoint frame can be built up with pieces of scrap wood, such as strips of wood or planks of wood which are bonded to the main plank of the fingerjoint plywood frame.

The fifth step is to prepare the polyurethane mixture. The polyurethane mixture can be made using the following formula.

A: POL

| | |
|---|---|
| Polyol | 90-96% |
| Additive | 1-3% |
| EG | 0.5-1.5% |
| H₂O | 0.07-.20% |
| SI 02 | 0.5-1.5% |
| Catalyst T-9 | 0.04-0.12% |
| Catalyst LV-33 | 0.30-0.90% |
| Catalyst C-100 | 0.30-0.90% |

B: MDI (Polymeric)

| | |
|---|---|
| Lupranat M20S | 100% |

The amounts above are based on making a door with a total weight of 25 kg, with a density of 350-600 kg/m³ preferably 450-500 kg/m³. The mixtures are preferably separated into a pair of containers, namely containers A and B of approximately 8.5 kg each which are heated separately with a high pressure PU heating machine to between 20-35 degrees Celsius.

The polyurethane mixture is then injected into the mold. The top and bottom of the mold surface is first sprayed with wax using an air gun. The water heater is then activated to approximately 45° C. to heat the mold using the copper pipes previously installed. Then, the fingerjoint frame is secured into the mold frame. The mold frame is that closed and locked, and the frame is slightly slanted to allow the PU mixture to flow down. The PU mixture is injected from the high pressure PU machine through a pouring mouth for approximately 30 seconds, at a pressure of 150 kg/s. Preferably, a plurality of exhausts vents at the bottom of the frame allow air to flow out of the frame. Once the injection is complete, the exhaust vents are plugged with plugs. Immediately after the injection, the mold frame is rotated slowly (first counter-clockwise, then clockwise) for 1 minute to allow the PU mixture to flow thoroughly over the fingerjoint frame.

Then, one must allow at least about 30 minutes for the PU mixture to bond with the fingerjoint frame and dry before removing the door. When there is greater temperature difference, such as in the winter, one must allow approximately up to 60 minutes to avoid shrinkage due to the temperature difference.

The seventh step is to remove the polyurethane door from the mold and set the door aside for complete curing, after which the door can then be cleaned and painted.

1. A door comprising:
a. a wood frame core generally shaped as a planar plank having a first side and a second side;
b. a polyurethane outer layer encapsulating the wood frame plank core, wherein the polyurethane outer layer has a density of 350-600 kg/m³;
c. a plurality of concave embossments disposed on the polyurethane outer layer;
d. an AB formula for forming the polyurethane outer layer, having a formula comprising a first component comprising a Polyol of at least 90% by weight, and a second component comprising Lupranat M20S.

2. The door of claim 1, wherein the wood frame core further comprises strips of wood material disposed on the wood frame core for building up portions of the wood frame core.

3. The door of claim 1, wherein the fingerjoint plywood is preferably 25 mm thick and 10.7 kg and can be about 22-23 mm thickness as well.

4. The door of claim 1, wherein the AB formula comprises:
i. a first component comprising by weight:

| | |
|---|---|
| Polyol | 90-96% |
| Additive | 1-3% |
| EG | 0.5-1.5% |
| H₂O | 0.07-.20% |
| SI 02 | 0.5-1.5% |
| Catalyst T-9 | 0.04-0.12% |
| Catalyst LV-33 | 0.30-0.90% |
| Catalyst C-100 | 0.30-0.90% |

ii. a second component comprising by weight:

| | |
|---|---|
| Lupranat M20S | 100% |

5. The door of claim 4, wherein the wood frame core further comprises strips of wood material disposed on the wood frame core for building up portions of the wood frame core.

6. The door of claim 4, wherein the fingerjoint plywood is preferably 25 mm thick and 10.7 kg and can be about 22-23 mm thickness as well.

7. The method of constructing a door comprising the steps of:
a. preparing a model door;
b. forming a mold frame;
c. forming a mold, comprising the steps of:
i. laying a first layer of epoxy resin, a hardening agent and a structural cloth
ii. laying a second layer of fine sand having additional epoxy resin and additional hardening agent bonded to the first layer;
iii. laying a conduit pipe on the second layer;
iv. laying a third layer of quartz sand having additional epoxy resin and additional hardening agent over the conduit pipe.
d. forming a a wood frame core generally shaped as a planar plank having a first side and a second side, and placing the wood frame core into the mold;
e. preparing an AB formula which is a polyurethane mixture having a formula comprising a first component comprising a Polyol of at least 90% by weight, and a second component comprising Lupranat M20S;
f. injecting the polyurethane mixture into the mold to form a polyurethane outer layer, wherein the polyurethane outer layer encapsulates the wood frame plank core, wherein the polyurethane outer layer has a density of 350-600 kg/m³;
g. forming a plurality of concave embossments disposed on the polyurethane outer layer;
h. waiting for the polyurethane mixture to cure; and
i. removing the door from the mold.

8. The method of constructing a door of claim 7, wherein the wood frame core further comprises strips of wood material disposed on the wood frame core for building up portions of the wood frame core.

9. The method of constructing a door of claim 7, wherein the fingerjoint plywood is preferably 25 mm thick and 10.7 kg and can be about 22-23 mm thickness as well.

10. The method of constructing a door of claim 7, wherein the AB formula comprises:
i. a first component comprising by weight:

| | |
|---|---|
| Polyol | 90-96% |
| Additive | 1-3% |
| EG | 0.5-1.5% |
| H₂O | 0.07-.20% |
| SI 02 | 0.5-1.5% |
| Catalyst T-9 | 0.04-0.12% |
| Catalyst LV-33 | 0.30-0.90% |
| Catalyst C-100 | 0.30-0.90% |

ii. a second component comprising by weight:

| | |
|---|---|
| Lupranat M20S | 100% |

11. The method of constructing a door of claim 10, wherein the wood frame core further comprises strips of wood material disposed on the wood frame core for building up portions of the wood frame core.

12. The method of constructing a door of claim 10, wherein the fingerjoint plywood is preferably 25 mm thick and 10.7 kg and can be about 22-23 mm thickness as well.
